(19) United States
(12) Patent Application Publication
(10) Pub. No.: US 2002/0188482 A1
(43) Pub. Date: Dec. 12, 2002

(54) System and method for package return insurance

(76) Inventor: Jeffrey Edward Friend, Whitefish, WI (US)

Correspondence Address: JEFFREY EDWARD FRIEND, 330 E. HENRY CLAY #5, WHITEFISH BAY, WI, 53217, US

(21) Appl. No.: 10/053,214

(22) Filed: Jan. 14, 2002

Related U.S. Application Data
(60) Provisional application No. 60/296,360, filed on Jun. 6, 2001.

(51) Int. Cl. G06F 17/60

(52) U.S. Cl. 705/4

(57) ABSTRACT

A system and method for package return insurance whereby the premiums paid go to cover the costs associated with package returns in the event that a consumer elects to exercise such a return. The premiums are automatically calculated and take different forms including but not limited to a fee or combinations of fees paid by consumers at the point of purchase, paid by merchants at the point of purchase, paid by carriers in advance of covered package deliveries directed to intermediate locations (e.g. pack ‘n’ ship retail centers). As they are charged, the fees are debited or charged against the account of the respective party or parties and credited to a common fund referred to as the “Premium Pool.” Funds from the Premium Pool are then paid out in response to claims submitted by carriers and merchants and/or their agents for reimbursement of costs they incurred in handling, processing and transporting actual package returns.

### FEDERALLY SPONSORED RESEARCH

Not Applicable

### SEQUENCE LISTING OR PROGRAM

Not Applicable

### FIELD OF INVENTION

The present invention is related to a system and method for a package return insurance service whereby the premium paid for such insurance constitutes a fee or fees applied in the course of carrying out electronic commerce transactions. Coverage granted by package return insurance allows one or more parties to an electronic commerce transaction to avoid some or all of the costs associated with the handling, processing and transporting package returns.

### BACKGROUND OF THE INVENTION

Today (i.e. the date of this filing) there is ample evidence suggesting that costs associated with returning goods purchased remotely either over the Internet or the telephone pose as an obstacle to the full realization of the benefits of electronic commerce.

Forrester Research reports that 54% of online users surveyed say they would buy more products online if it were easier to return merchandise. NFO Interactive found that one-fifth of online shoppers surveyed say they often keep items they want to return because they simply don't want to pay return shipping fees.

Based on the study findings highlighted above, it can be predicted that the ever-increasing competitiveness of the evolving electronic commerce marketplace will soon cause many merchants to feel pressured to make a practice of offering free returns. This would include not only free shipping and handling, but possibly even the free packaging of returns at convenient drop-off locations in an effort to make returns as easy as possible.

The problem is that inefficiencies exist that limit the ability to translate these practices to the e-commerce marketplace at large.

One limitation is cost. While larger multi-channel retailers have established profit margins allowing them to absorb the costs of free returns, many other Internet retailers either continue to struggle toward profitability or maintain the thinnest of profit margins. Some of these smaller retailers go a different route, offering free returns so long as customers agree to return items for in-store credit instead of a refund. But this fails to make package returns easy or affordable either for consumers.

Another limitation is simply the lack of a standard means and process by which merchants and consumers are both able to take full advantage of the benefits brought by a marketplace where concerns over the cost and inconvenience of package returns are no longer an issue.

This invention takes a unique approach to the problem of package returns by applying the concept of insurance much in the same way it has been applied to other areas of risk. Here, it is the decision by any one consumer to exercise the return of a purchased item that is viewed as an unpredictable event.

No known attempts have not been made to solve the problem of package returns in this way. However, systems and methods have been created to provide other innovative types of insurance coverage without any vision to solving the problem of package returns.

In U.S. Pat. No. 4,766,539, a method is described for a system and method for writing a policy insuring against the occurrence of a specified weather condition whereby the historical data of weather conditions is accumulated and stored in a computer memory. When a policy is to be written, information identifying the amount of the policy, the weather condition against which the policy is to insure, the location of interest, and the time period of interest is applied to the computer which then calculates the policy premium.

U.S. Pat. No. 5,704,045 describes a system and method of creating agreements that promise payments, based on loss from risks including investment risks. The system operates by accepting risk through contractual obligations, transferring a portion of the risk to investors and includes means for absolute assurance of timely payment to contract holders, and segregation, of the interests of particular investors to specifically identified risks in a risk to capital matching system.

U.S. Pat. No. 6,128,598 describes a system and method for providing a foreign exchange insurance policy that automatically considers factors such as the type of currency, exchange rate, amount of coverage, and period of coverage, to determine a premium. Users can access the system using credit cards, ATMs, banks or other media.

Accordingly, it is desirable to provide a means by which the concept of insurance is applied to the above described problems of package returns whereby such insurance would allow merchants and consumers to avoid some or all of the costs of transporting and processing package returns. The premium paid for such insurance coverage would constitute a fee or fees charged separately to existing shipping & handling fees both as a matter of process and as part of those steps involved with completing electronic commerce transactions involving remote-purchased goods which are then delivered by physical means.

Further, it is desirable to provide a means by which the calculated costs associated with processing and transporting package returns are able to be leveraged so as to establish a sustainable baseline value for personally and non-personally identifiable information exchanged between merchants and consumers during electronic commerce transactions with the intention that limited use of such information would help maximize efficiencies and benefits in the marketplace.

For the purpose of this application, the term “Return Insurance” is used as a matter of convenience for clarity in describing the invention. This is to be distinguished from the current limited commercial use of the term. Such use describes the purchase of insurance by a first party (e.g. collector) to cover the value of an item (e.g. collectible) being sent to a second party (e.g. appraiser) for inspection (e.g. appraisal) in the event that such item is damaged, lost or stolen. The insurance does not cover costs associated with the handling, processing or transporting of package returns. However, it is likely the term Return Insurance will come to be generally associated with such coverage given the benefits brought by this invention and the appropriateness of the term in describing those benefits.

### SUMMARY OF THE INVENTION

The present invention involves generating and executing insurance policies covering some or all of the costs associated with the transporting and processing package returns by automatically determining an appropriate premium or premiums and processing transactions under the return insurance policies.

Specifically, a method of providing a return insurance policy consistent with this invention comprising a central controller receiving policy requirements from a user for the return insurance policy; storing the policy requirements and the corresponding user ID; accessing data corresponding to the specified item purchase and current market conditions; estimating user response rates and premium totals from the accessed data; and computing a premium cost based on data corresponding to the specified item purchase, user response rates and premium totals. The received policy requirements further include the data corresponding to the specified item purchase, the cost of transporting and processing the return of the specified item purchase, the type of coverage, and a period of coverage.

According to another aspect of the present invention, a system for providing a return insurance policy consistent with this invention comprises receiving means, a database, accessing means, estimating means and computing means. The receiving means receives policy requirements from a user for the return insurance policy, including a user ID, data corresponding to the specified item purchase, the cost of transporting and processing the return of a specified item purchase, the type of coverage, and a period of coverage. The database stores the policy requirements and the corresponding user ID. The accessing means access data including historic return shipping transportation and processing rates corresponding to the specified item purchase and current market conditions. The estimating means estimates user response rates and premium totals from the accessed data. Finally, the computing means computes a premium cost based on user response rates and premium totals.

### BRIEF DESCRIPTION OF THE DRAWINGS

FIG. 1 is an overview of the system for a package return insurance service whereby the premium paid for such insurance constitutes a fee applied in the course of carrying out electronic payment transactions.

FIG. 2 is a detailed view of the various components and databases contained within the central controller.

FIG. 3 is a flowchart illustrating the preferred method for presenting the option of Return Insurance coverage for response by a consumer.

FIG. 4 is a flowchart illustrating the preferred method for presenting the option of ultimate or remote destination return for response by a consumer.

FIG. 5 is a flowchart illustrating the preferred method for presenting the option of extended coverage for response by a consumer.

FIG. 6 is a diagram showing the various contributors to the Premium Pool according to the preferred process.

FIG. 7 is a flowchart illustrating the preferred method whereby the various contributions are made to the Premium Pool.

FIG. 8 is a flowchart illustrating the preferred method whereby the central controller updates the status of stored Return Insurance policies.

FIG. 9 is a flowchart illustrating the preferred method whereby the central controller verifies Return Insurance coverage by searching for a stored transaction identification number (e.g. credit or debit card number or other proprietary identification number or code) entered at the point that a package return is initiated.

FIG. 10 is a flowchart illustrating the preferred method whereby the central controller verifies if a Return Insurance policy is active or expired.

FIG. 11 is a flowchart illustrating the preferred method whereby the central controller determines whether a package return is being initiated as an ultimate or remote destination return and subsequently verifies whether an active Return Insurance policy provides for coverage for an ultimate destination return.

FIG. 12 is a flowchart illustrating the preferred method whereby an ATM and ATM network is used as a means of securely and reliably identifying a cardholder conducting a package pickup, shipment, or return.

FIG. 13 is a flowchart illustrating the preferred method whereby an ATM network is used as a means of authenticating a cardholder conducting a package pickup, shipment, or return.

### DETAILED DESCRIPTION OF THE INVENTION INCLUDING THE PREFERRED EMBODIMENTS

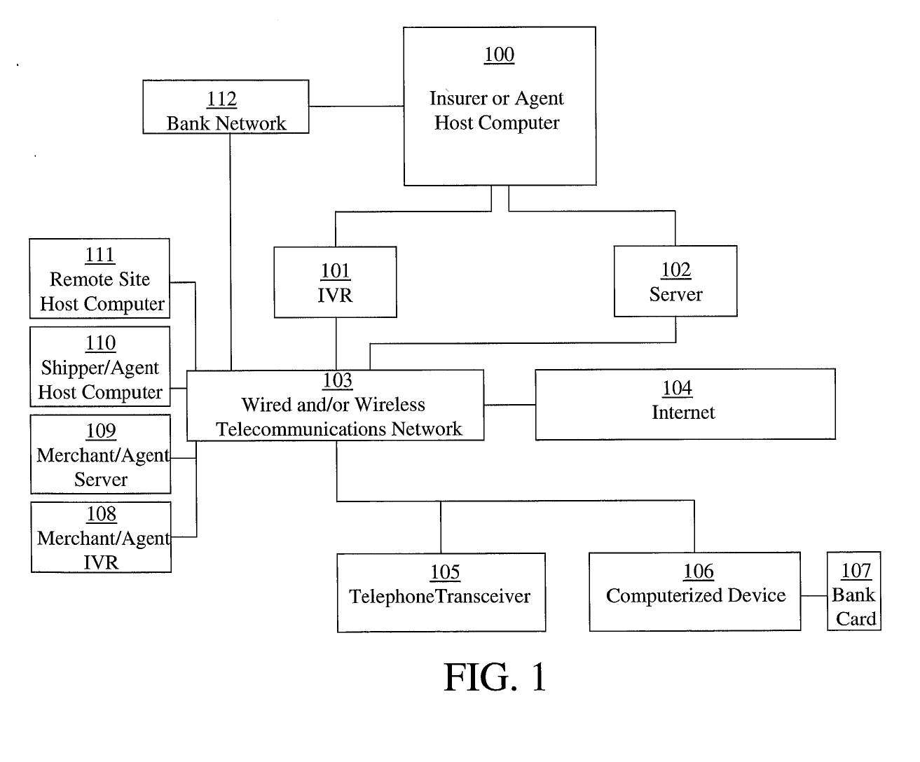

FIG. 1 illustrates a system consistent with the present invention including a central controller contained within Insurer or Agent Host Computer 100 and connected by way of Server 102, Wired and/or Wireless Telecommunications Network 103 and Internet 104 to Computerized Device 106; connected by way of IVR 101 and Wired and/or Wireless Telecommunications Network 103 to Telephone Transceiver 105; connected by way of Server 102, Wired and/or Wireless Telecommunications Network 103 and Internet 104 to Merchant and/or Agent Server 109; connected by way of Server 102, Wired and/or Wireless Telecommunications Network 103 and Internet 104 to Shipper and/or Agent Host Computer 110; connected by way of Server 102, Wired and/or Wireless Telecommunications Network 103 and Internet 104 to Remote Site Host Computer 111 (e.g. pack ‘n’ ship retail center).

Also shown as part of FIG. 1 is Computerized Device 106 connected by way of Wired and/or Wireless Telecommunications Network 103 and Internet 104 to Merchant and/or Agent Server 109.

Also shown as part of FIG. 1 is Telephone Transceiver 105 connected by way of Wired and/or Wireless Telecommunications Network 103 to Merchant and/or Agent IVR 108.

Also shown as part of FIG. 1 is Bank Card 107 connected to Computerized Device 106 which is then connected by way of Wired and/or Wireless Telecommunications Network 103 to Bank Network 112 wherein Computerized Device 106 is an ATM.

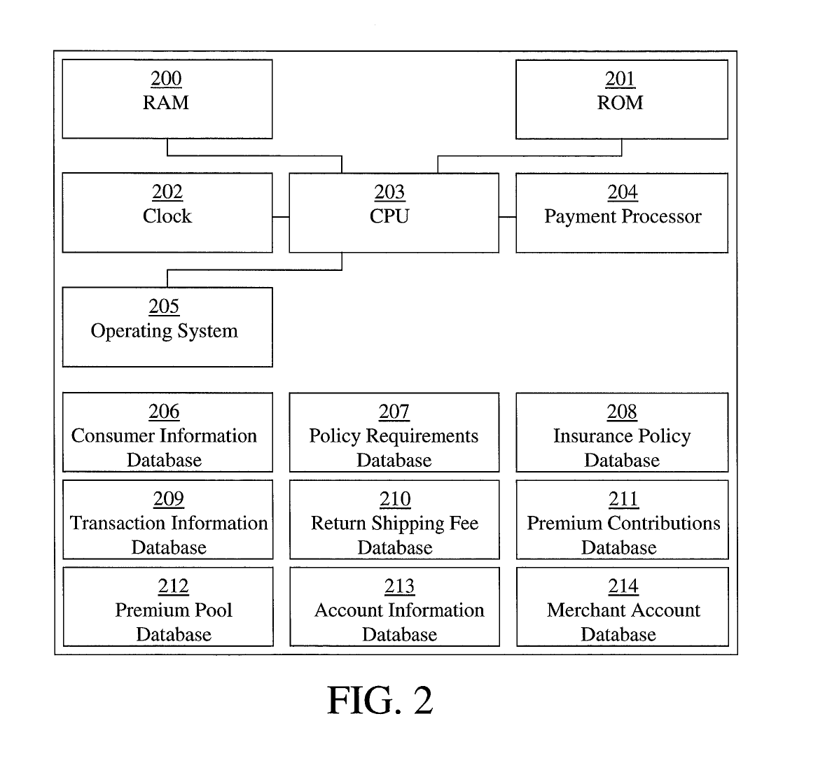

FIG. 2 shows a block diagram of the central controller contained within Insurer or Agent Host Computer 100. The central controller preferably includes a CPU (Central Processor Unit) 203 connected to a RAM (Random Access Memory) 200, a ROM (Read Only Memory) 201, a Payment Processor 204, a Clock 202, an Operating System 205 and a data storage device.

The central controller operates as a primary server, both receiving and transmitting communications with the various devices highlighted in FIG. 1. In the case of communications between the central controller an Merchant and/or Agent Server 109, Shipper and/or Agent Host Computer 110, and Remote Site Host Computer 111, such communications are preferably facilitated by way of direct connection to APIs (Application Program Interface) operating from servers located on premise. The central controller is preferably capable of high volume processing, performing a significant number of mathematical calculations in processing communications and database searches. The central controller may be a conventional personal computer or a computer workstation with sufficient memory and processing capability. The means for encrypting and authenticating communications would also be contained within the central controller per commonly employed practices and available technologies.

Payment Processor 204 supports the transfer and exchange of payments, charges, or debits. These include such services as on-line credit authorizations, credit card settlement, payments to transaction networks, and payment aggregation. Payment Processor 204 preferably comprises a microprocessor but alternatively may be configured as part of CPU 203.

The data storage device contains databases used in processing transactions in the present invention, including a Consumer Information Database 206, a Policy Requirements Database 207, an Insurance Policy Database 208, a Transaction Information Database 209, a Return Shipping Fee Database 210, a Premium Contributions Database 211, a Premium Pool Database 212, an Account Information Database 213, and a Merchant Account Database 214.

Consumer Information Database 206 maintains both personally and non-personally identifiable data about consumers. In one embodiment, fields containing personally identifiable data such as name, address, credit card number, phone number, social security number, and e-mail address are included, as are additional fields containing non-personally identifiable information such as demographic profile information and/or personal preference information regarding either past product or service purchases or possible future purchases.

This information is preferably obtained when the consumer first requests generation of a return insurance policy on the system. The type and amount of information obtained depends on whether the consumer opts for a “paid for” return insurance policy in which the consumer agrees to pay a nominal fee as a premium paid to avoid future costs in the event of a package return. In this case, information might be limited to only that personally identifiable information required for the purchase and possible return of a good. An alternative option available to the consumer is for an “opt in” return insurance policy in which the consumer is able to forego the payment of a nominal fee in exchange for agreeing to fill out an online questionnaire revealing non-personally identifiable information and availing themselves to direct access by merchants and their affiliates via email marketing, direct mail marketing, telemarketing, instant messaging, etc. This second option would be facilitated by the creation of pseudo e-mail addresses so as to minimize any privacy concerns and as a result maximize overall consumer participation. Such a service preferably includes the integration of technology from outside vendors. The technology is readily available today as evidenced by such long established network-based pseudo email services such as Microsoft's Hotmail which make use of alphanumerical strings in place of a user's primary e-mail address.

Consumer Information Database 206 also contains the tracking number of each return insurance policy generated by the consumer in con junction with the purchase of a good.

Policy Requirements Database 207 maintains data on policy requirements generated by the consumer, and preferably includes fields such as end-user ID, credit card number, specified item purchase, return shipping transportation and processing rates, start date of coverage, end date of coverage, type of coverage, and policy requirements tracking number.

Insurance Policy Database 208 tracks each return insurance policy generated by the consumer and preferably includes fields such as end-user ID number, insurance policy tracking number, date generated, policy requirements tracking number, and status of premium payment. Each insurance policy may have an associated status of insurance policy such as “active” or “expired.”

Transaction Information Database 209 stores all transaction data relating to the return insurance policy. This database is indexed by the tracking number of the return insurance policy, and preferably contains fields such as end-user ID number, the amount of the calculated consumer premium contribution, the date of transaction, the anticipated return shipping transportation and processing rate, and merchant & carrier ID numbers.

Return Shipping Fee Database 210 facilitates the processing of transaction data by storing current and historic return shipping and processing rates (e.g. restocking fees) for every carrier and merchant and/or their respective agents per specified items. It is preferable that carriers and merchants will be primarily responsible for updating return shipping and processing rates per their return insurance program contracts.

Premium Contributions Database 211 provides an accounting for the return insurance premium contributions made by individual consumers, merchants, and carriers in conjunction with administered return insurance programs.

Premium Pool Database 212 provides an accounting at a given point in time for the total aggregate value of return insurance premiums contributed by consumers, merchants and carriers in conjunction with a specific administered return insurance program relative to the total value obligated to be paid out in response to claims submitted by carriers and merchants and/or their agents for reimbursement of costs incurred in handling, processing and transporting actual package returns. In addition, such accounting preferably includes that value maintained in the Premium Pool (i.e. central fund) as a matter of maintaining sufficient funds to assure the viability of the return insurance program and the profitability of the company overseeing its administration.

Account Information Database 213 allows the central controller to track amounts owed to carriers and merchants and/or their agents in response to claims submitted. It is preferable that this would include a 15 or 30 day billing cycle that would have this amount remaining in the custody of the company administering the return insurance program for that period of time.

Merchant Account Database 214 supports pre-established accounts with individual merchants so as to facilitate providing for a service by which consumers are able to receive immediate or timely credit for the total amount paid for purchased item upon its return. This service provided by the return insurance administrator would function to augment the services of those merchants not already offering immediate or timely credit to their customers but wishing to do so.

An aspect of the invention provides that select information contained within the data storage device will be made available on a need-to-know basis to merchants and carriers participating in an administered return insurance program. Access to updated information will be granted around-the-clock via a password-protected web site.

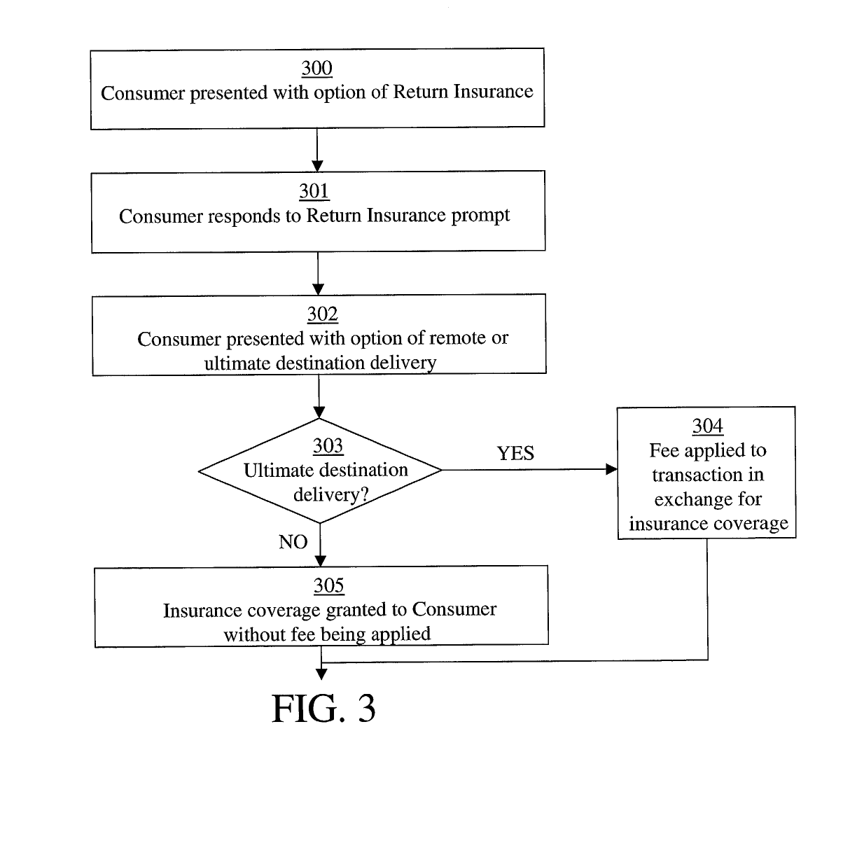

FIG. 3 illustrates a preferred process by which a consumer is presented with the option to purchase return insurance 300. The option may be presented in the form of an electronic scripted message appearing on a merchant or insurer web site at the point of checkout, an electronic voice message conveyed to the consumer through Merchant/Agent IVR 108 or IVR 101 at the point of checkout, or a spoken message communicated to the consumer by a “live” agent operating on behalf of the merchant or the insurer a the point of checkout. By whatever means it is communicated, the price quote for return insurance coverage will amount to a nominal fee calculated preferably in real time given various factors at play.

Such factors include the total value amount of consumer contributions being made to the Premium Pool at any given point in time. Preferably, the invention always attempts to maximize this value by adjusting the advertised amount up or down in response to the ongoing frequency of user purchases of “paid for” return insurance coverage. This function would preferably be performed by a “pricing engine” operating in conjunction with the central controller and the data storage device and utilizing a custom-written software application. The core technology called for by the pricing engine is readily available and in use today for similar applications involving what is commonly referred to as “reverse auctions.”

When a consumer responds positively to the return insurance prompt 301, the pricing engine automatically calculates the consumer premium contribution. The difference of that amount and the expected total cost of a possible future package return for the specific item being purchased is also calculated whereby the central controller automatically bills the merchant for that difference. The consumer and merchant premium contributions are then credited to the Premium Pool.

Specifically, the other possible factors that may be taken into account in pricing return insurance include but are not limited to: the expected carrier shipping rate to be charged in the event of a return shipment of the item being purchased; the expected total value amount of handling or processing fees (e.g. restocking fees) to be charged by the carrier or the merchant and/or their agent in the event of a return shipment of the item being purchased; the total value amount of claims being submitted by carriers and merchants and/or their agents for reimbursement of costs incurred in handling, processing and transporting actual package returns at a given point in time as reflected by the return rate of covered goods; the shipping weight of the package at the time of purchase; the distance over which the package will be shipped in the event of a return; the shipping rate expected to be charged by a carrier in the event of a return; the average return rate for a particular type of good (e.g. books vs. apparel) as sold by a particular merchant, the average return rate of an individual merchant in comparison to all other merchants selling similar types of goods, the average return rate of individual consumers in comparison to all other consumers buying similar types of goods.

The invention will also preferably maintain an ongoing record of totals regarding insured package deliveries and returns, premium contributions and claim reimbursements, both as a whole and specific to individual members of specific return insurance programs. This makes possible the real-time comparison of the average return rate for individual merchants to all other merchants selling similar types of goods, as well as the average return rate of individual consumers to all other consumers buying similar types of goods. Such comparison would allow return insurance rates to be adjusted on an individual basis, potentially charging lower rates to those merchants and consumers with lower than average rates of return and higher rates to those with higher than average rates of return.

In addition to the preferred method of presenting a consumer with the single option of “paid for” return insurance coverage as shown in FIG. 3, an alternative not shown is to simultaneously present the consumer with the second option for “free” return insurance coverage in exchange for their agreement to provide answers to an online questionnaire or an audible questionnaire depending on whether the purchase is being made over the Internet or the telephone. This would preferably involve the consumer being directed to Server 102 in the case of an Internet purchase or IVR 101 in the case of a telephone purchase.

In addition to the answering questions regarding demographics or preference data with regard to past or possible future product or service purchases, the consumer would also be asked to submit their email address and other personally identifiable information (e.g. address, phone number, etc) and agree to be avail themselves to direct contact by the merchant and the merchant's affiliates through such means as e-mail marketing, direct mail marketing, telemarketing, instant messaging, etc.

In the case of a consumer agreeing to this second alternative of free return insurance in exchange for their agreement to “opt in,” the central controller would automatically bill the merchant for the expected total cost of a possible future package return for the specific item being purchased.

According to another aspect of the invention, consumers would retain the option to “opt out” of the above described marketing relationships with merchants. The invention would provide consumers with the means of doing so without necessarily severing similar established one-to-one marketing relationships with other merchants or their affiliates. However, choosing to opt out of a specific one-to-one relationship would also cancel automatic free return insurance coverage for future purchases made with that particular merchant.

Should a consumer elect to permit the “opt in” arrangement to continue with specific merchants, the same process would continue by which the central controller would automatically bill the merchant for the expected total cost of a possible future package return for a specific item being purchased.

FIG. 3 also illustrates a consumer being presented with the additional option of remote or ultimate destination delivery in which case the choice of remote destination delivery would afford the consumer another form of free return insurance coverage for the specific item being purchased. This form of free return insurance takes advantage of the estimated 20-25% in cost savings that carriers would realize as a result of making multiple-package deliveries to more easily accessible intermediate locations (e.g. pack ‘n’ ship retail centers) as opposed to single-package deliveries made door-to-door to consumer homes.

The preferred method would have the central controller bill the carrier for a portion of this savings amount as a replacement for the premium contribution that would have otherwise been charged to the consumer as shown in FIG. 3. However, an alternative method would be to bill the carrier for a portion of this savings amount as a partial or total replacement for the premium contribution that would have otherwise been charged to the merchant. In this case, the consumer would still be charged the calculated premium contribution unless they qualified for “opt in” return insurance coverage whereby the merchant would still be billed for the calculated consumer portion of the total expected cost of a possible future package return for the specific item being purchased.

This invention is the first known transaction process to attempt to tap all or a portion of these cost savings in an attempt to create a value proposition. Participating shippers would agree to contribute a portion of their savings amount as a premium payment to the Premium Pool knowing they stand to realize increased revenue from what would be expected to be an overall increase in package volume. The total premium paid as a matter of funding a return insurance program could also and is in fact likely to involve various combinations of the above mentioned premiums.

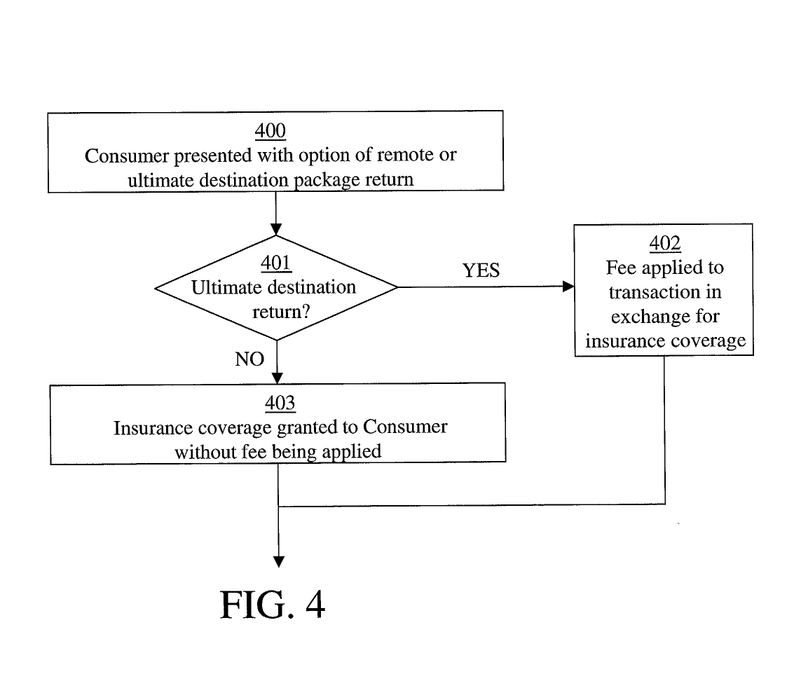

FIG. 4 is a flowchart illustrating the preferred method for presenting the option of ultimate or remote destination return for response by a consumer at the point of checkout. The consumer is presented with the option of remote or ultimate destination package return 400. If “Yes” to ultimate destination return (i.e. a package return to be picked up at their home or office) 401 then an additional fee is applied to the transaction in exchange for return insurance coverage 402. This fee may take the form of an amount calculated in real time similar to the consumer premium contribution highlighted in FIG. 3 or a pre-calculated fee, with the consideration that such a fee will more than absorb the added cost of an ultimate destination return. If “No” to ultimate destination return (e.g. a package return to be picked up at a pack ‘n’ ship retail center) then return insurance coverage is granted to the consumer without an additional fee being applied 403.

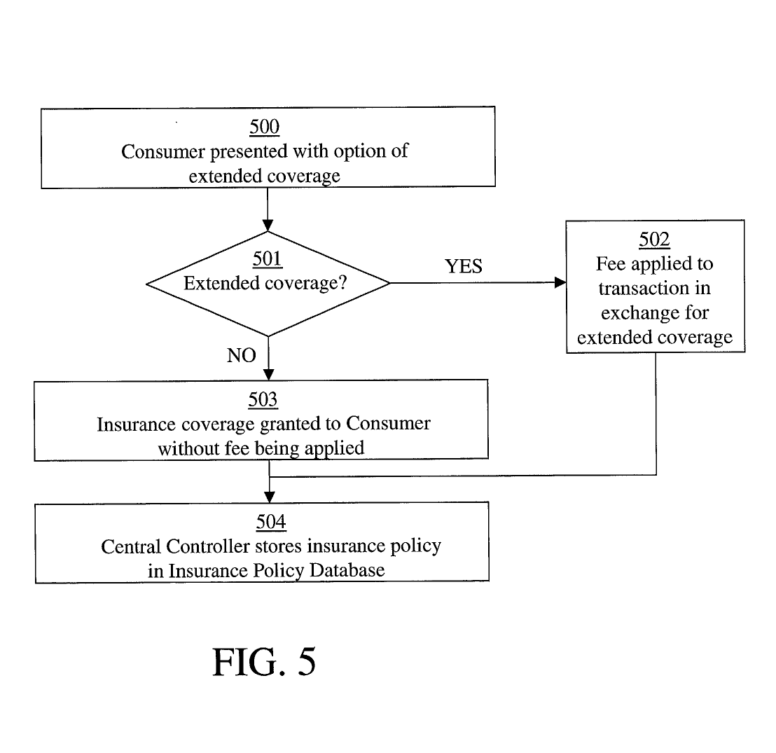

FIG. 5 is a flowchart illustrating the preferred method for presenting the option of extended coverage for response by a consumer at the point of checkout. The consumer is presented with the option of extended return insurance coverage for a specific period of time as provided for by the merchant from whom the purchase is being made 500. If “Yes” to extended coverage 501, then a fee is applied to the transaction 502. If “No” to extended coverage, then insurance coverage is granted to the consumer without a fee being applied 503. The central controller then stores the insurance policy in the Insurance Policy Database 504.

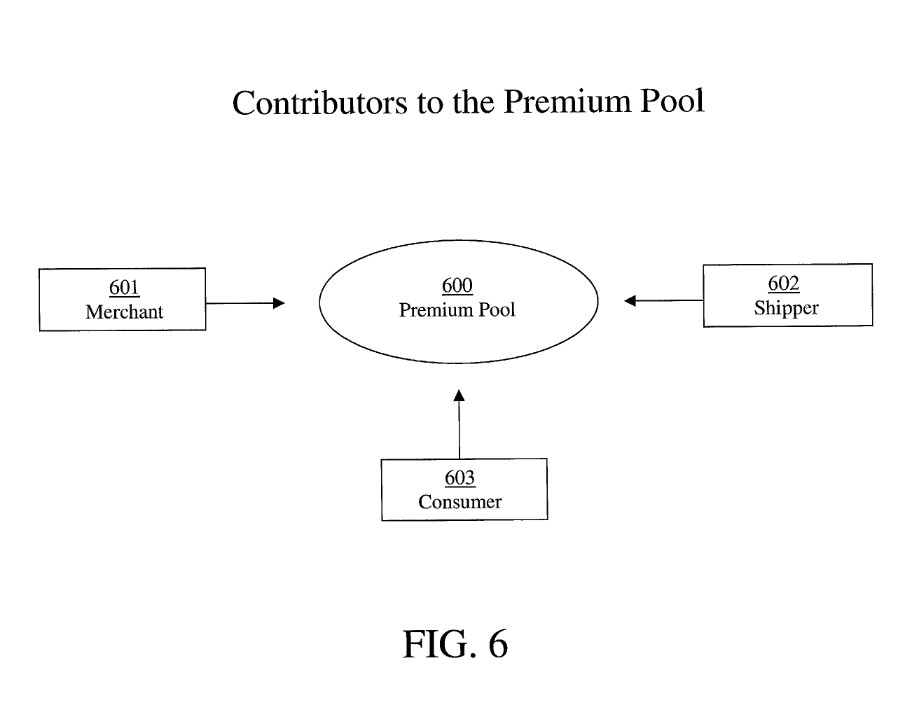

FIG. 6 is a diagram showing the various contributors to the Premium Pool according to the preferred method. As described above depending on the factors at play for a specific transaction, premium contributions may be made by the Merchant 601, the Shipper (i.e. Carrier) 602, and the Consumer 603 or a combination of these parties.

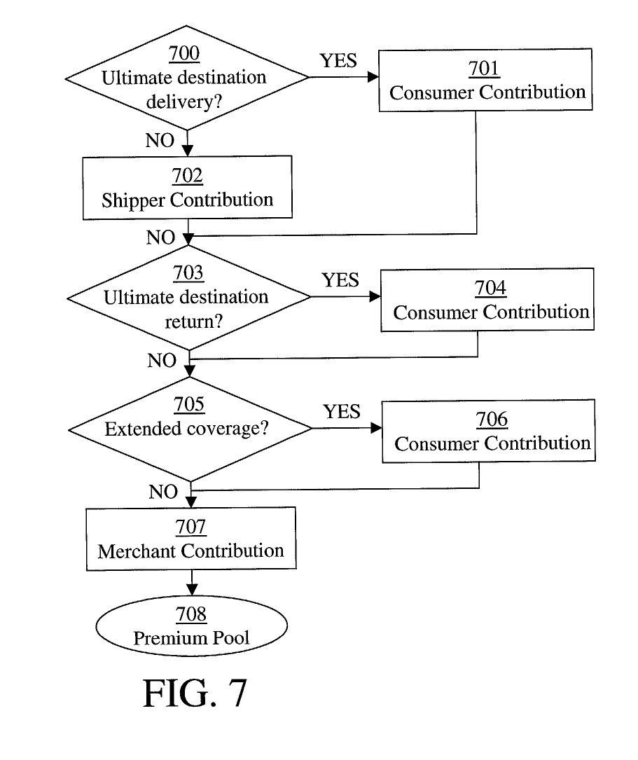

FIG. 7 is a flowchart summarizing the preferred method whereby the various contributions are made to the Premium Pool 708. If “Yes” to ultimate destination delivery 700, then a contribution by the consumer 701. If “No” to ultimate destination delivery, then a contribution by the shipper (i.e. carrier) 702. If “Yes” to ultimate destination package return 703, then a contribution by the consumer 704. If “Yes” to extended return insurance coverage 705, then a contribution by the consumer 706. If “No” to extended insurance coverage, then a contribution by the merchant 707.

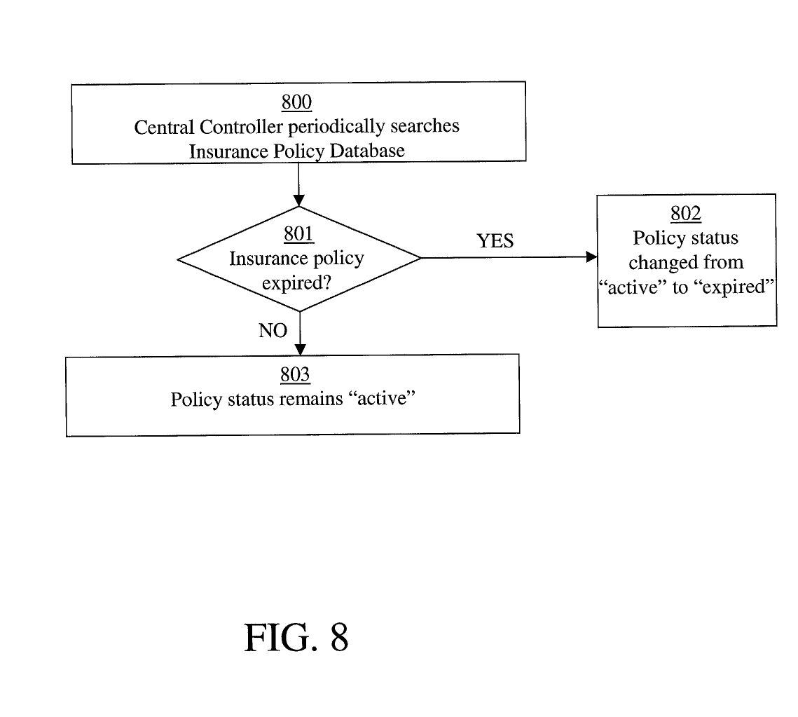

FIG. 8 is a flowchart illustrating the preferred method whereby the central controller updates the status of stored Return Insurance policies. The central controller periodically searches the Insurance Policy Database 800. If “Yes” to insurance policy expired 801, then the status of the policy is changed from “active” to “expired” 802. If “No” to insurance policy expired, then the status of the policy remains “active” 803.

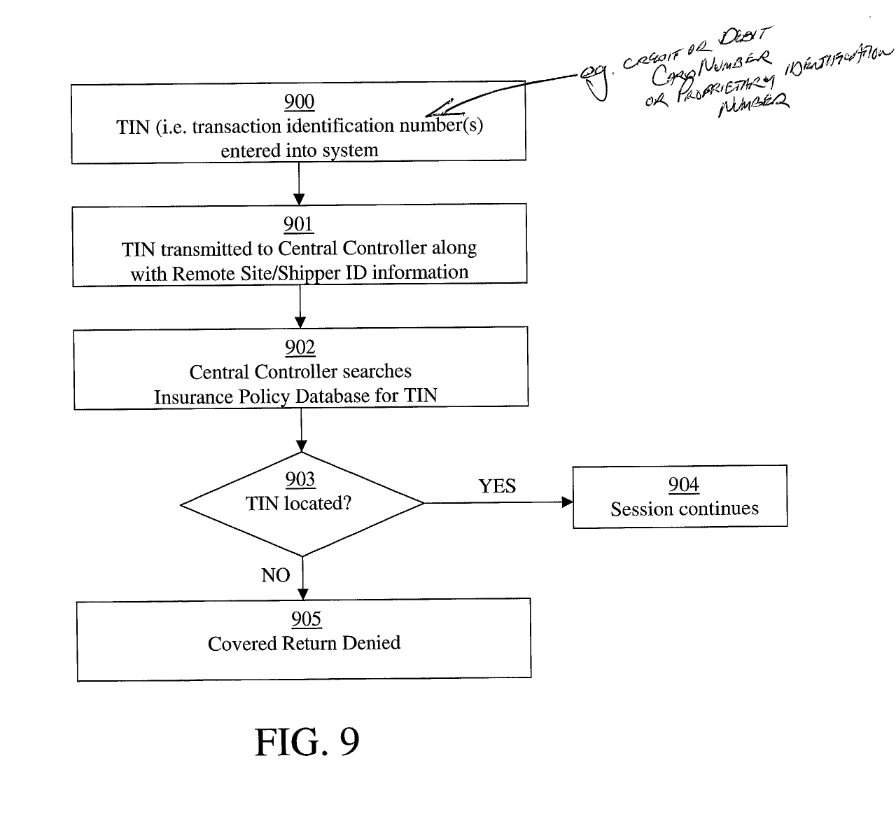

FIG. 9 is a flowchart illustrating the preferred method whereby the central controller verifies return insurance coverage by searching for a stored transaction identification number (e.g. credit or debit card number or other proprietary identification number or code) entered at the point that a package return is initiated. The transaction identification number is entered into the system 900 via Computerized Device 106. The transaction identification number is then transmitted to the central controller along with the remote site (e.g. pack ‘n’ ship retail center) and shipper (i.e. carrier) ID information 901 . Next, the central controller searches the insurance policy database for the entered transaction identification number 902. If “Yes” to the transaction identification number being located 903, then session continues 904. If “No to the transaction identification number being located, then insured package return denied 905.

An alternative to the process highlighted in FIG. 9 is to simply include a Return Label with pre-paid postage inside the package of an insured delivery when it is first shipped to the consumer. The consumer is then able to attach the Return Label to the outside of the package in the case of a return. The consumer could then simply drop the package into the mail for return shipment back to the address specified by the merchant. A further alternative would provide for Return Label to be printed by the consumer via Computerized Device 106 from the Merchant or Agent Server 109 or Server 102, or perhaps through a transmitted e-mail message. The exact address listed on the Return Label may then vary depending on the answers provided by the consumer to an online questionnaire.

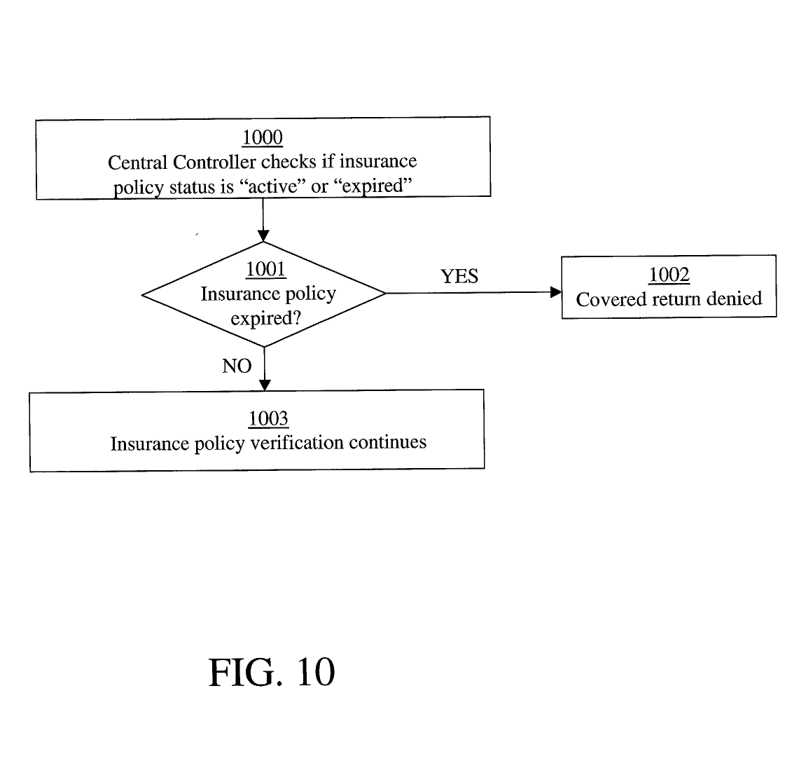

FIG. 10 is a flowchart illustrating the preferred method whereby the central controller verifies if a Return Insurance policy is active or expired during the course of a package return transaction via Computerized Device 106. The central controller checks if the status of the insurance policy is “active” or “expired” 1000. If “Yes” to the insurance policy being expired 1001, then the covered return is denied 1002. If “No” to the insurance policy being expired, then the insurance policy verification continues 1003.

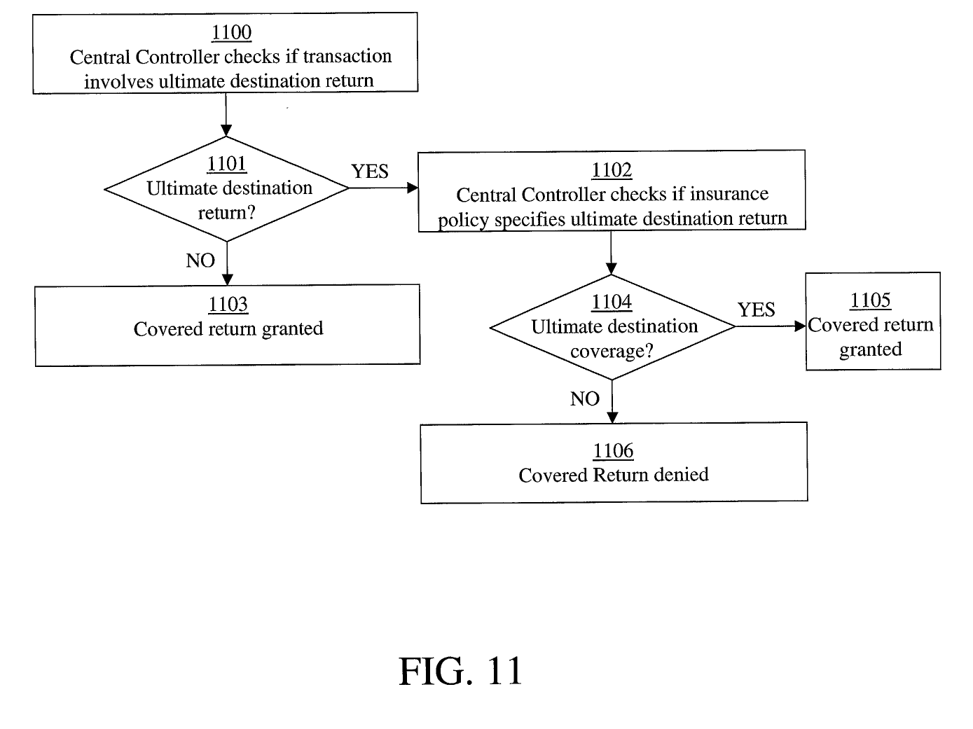

FIG. 11 is a flowchart illustrating the preferred method whereby the central controller determines whether a package return is being initiated as an ultimate or remote destination return and subsequently verifies whether an active Return Insurance policy provides for coverage for an ultimate destination return. In the case of an ultimate destination return, this would involve the entry of data into Computerized Device 106, in this case a remote wireless device carried by a representative of the agent. The central controller checks if the transaction involves an ultimate destination return 1100. If “Yes” to ultimate destination return 1101, then the central controller checks if the insurance policy specifies ultimate destination return 1102. If “Yes” to ultimate destination coverage 1104, then covered return is granted 1105. If “No” to ultimate destination coverage, then covered return denied 1106. If “No” to transaction involving an ultimate destination return 1101, then covered return granted 1103.

An additional feature of the invention provides for additional efficiency and security by operating in concert with a network connected to a database of pre-established user identities (e.g. automatic teller machine networks) thereby taking full advantage of the universality of established user populations identifiable through card numbers and password identification numbers or other verifiable information on file. The authentication process involves the submittal of user-specific information (e.g. card number and password identification number and/or name or other user-specific information spoken aloud and interpreted through use of voice recognition) to a local web-enabled computerized device. The local capture of submitted user-specific information. The transfer of such information to a network (e.g. electronic funds transfer network) and then to a central controller. The return of an authorization or denial from the central controller back to the network and then to the input device. If denial, the termination of session. If authorization, the activation of a web browser and electronic wallet stored locally in conjunction with the computerized terminal. The transfer of submitted user-specific information to the activated browser and electronic wallet. The immediate direction of the browser and electronic wallet to a pre-determined web site. The subsequent transfer of user-specific information from the browser and electronic wallet to the web site. The pre-authorization of the user-specific information for the purpose of a subsequent electronic payment transaction.

In the absence of a web-enabled computerized device (e.g. web-enabled ATM) the same basic process could be internalized through a strictly private line connection to the required databases (e.g. electronic funds network connection to the host computer at the cardholder's financial institution). In this instance, the authorization process would be similarly completed but absent of those steps required for the subsequent activation of a web browser.

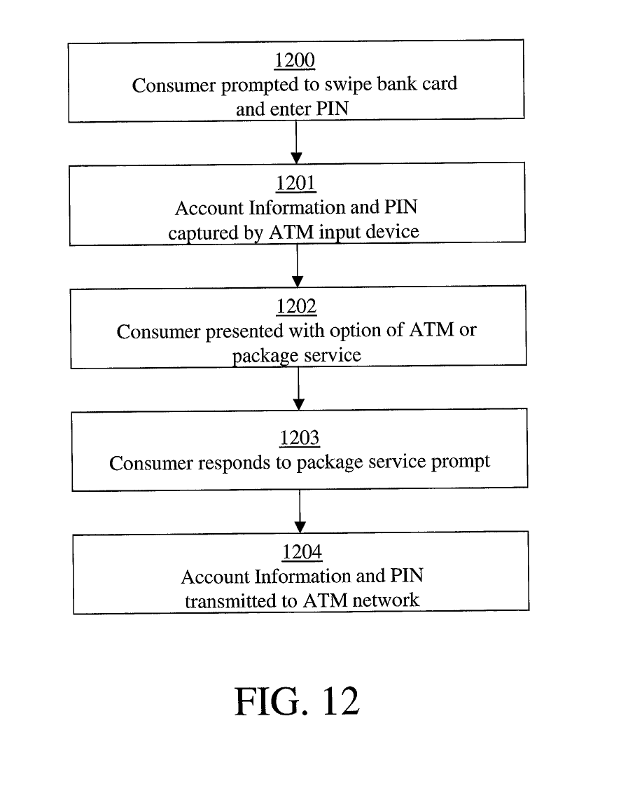

FIG. 12 is a flowchart illustrating the preferred method whereby an ATM and ATM network is used as a means of securely and reliably identifying a cardholder conducting a package pickup, shipment, or return. The consumer is prompted to swipe their bankcard (i.e. credit, debit, smart card) and enter their PIN (Personal Identification Number) 1200 into Computerized Device 106 where such device is an ATM. The account information and PIN are captured by the ATM input device 1201. Next the consumer is presented with option of regular ATM service or special package pickup, shipment or return service 1202. The consumer responds to the package service prompt 1203. The entered account information and PIN are transmitted 1204 to the ATM Network (i.e. Bank Network) 112.

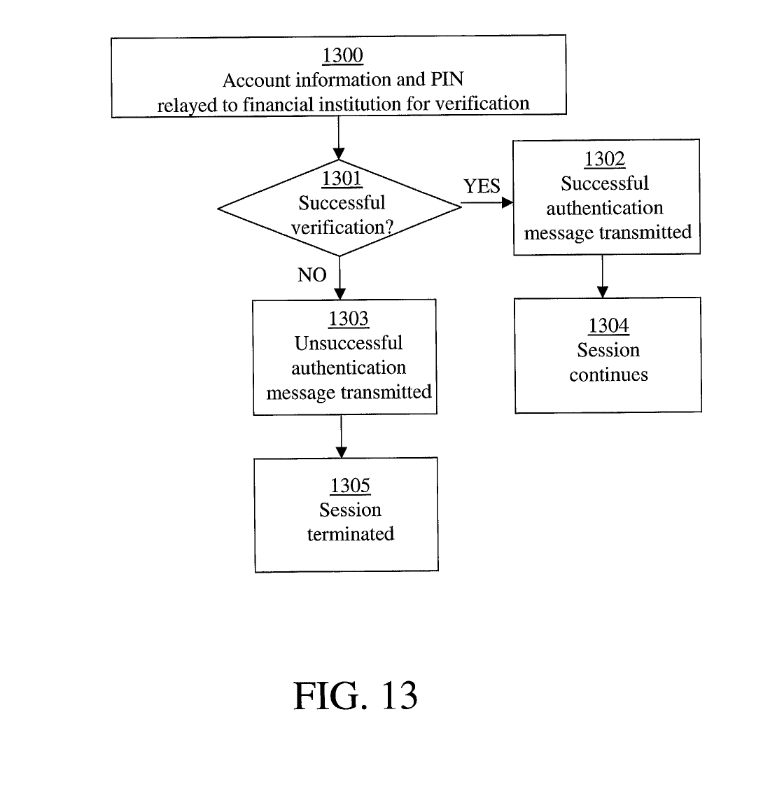

FIG. 13 is a flowchart illustrating the preferred method whereby an ATM network is used as a means of authenticating a cardholder conducting a package pickup, shipment, or return via Computerized Device 106 whereby such device is an ATM. Following entry by the cardholder, the account information and PIN are relayed to the cardholder's financial institution for verification 1300. If “Yes” to successful verification 1301, then successful authentication message is transmitted 1302 and the session continues 1304. If “No” to successful verification, then unsuccessful authentication message is transmitted 1303 and session is terminated 1305.

### ALTERNATIVE EMBODIMENTS

An alternative embodiment of the invention provides that the fee or fees contributed as return insurance premiums may also take the form of a percentage of the purchase price (e.g. credit card interchange fee or discount rate) or a flat fee (e.g. per transaction credit card fee) paid by a merchant and collected by the merchant bank and/or the merchant's acquirer/processor.

### CONCLUSION

It is important to note that it is not within the scope of this invention to prescribe the exact terms of an individual package return insurance policy or to present specific guidelines for setting the premiums necessary for funding such a policy. Rather, it is to disclose a system and methodology by which it is possible to efficiently and seamlessly collect premiums necessary for funding package return insurance within the framework of the e-commerce marketplace consisting of computers connected by wired and/or wireless telecommunications networks.

The hardware components needed for implementing this invention are currently in existence. However, it is expected that some custom written applications can be desired to assure smooth flow within the system. Such software can be readily written be a skilled programmer.

Although the invention has been described in detail, it is to be understood that variations therein and modifications thereto may be made by those skilled in the art without departing from the spirit and scope of the invention as set forth in the following claims. For example, the functions of the host computer can be provided by various microprocessors, servers, and memory storage devices working together in a system. The invention is not limited by the terminology used to describe the invention or various embodiments herein.

I claim:

1. A method of calculating a premium for a package return insurance policy, comprising:
receiving from a user a policy requirement for the package return insurance policy;
accessing data corresponding to a specified item purchase associated with the package return insurance policy;
and determining the premium based on the policy requirement and the accessed data.

2. The method of claim 1, further comprising storing the policy requirement.

3. The method of claim 1, further comprising providing an indication of the premium to the user.

4. The method of claim 1, further comprising arranging for a consumer, merchants, and carriers to provide a payment based on the respective premium.

5. The method of claim 1, wherein said determination is based on an expected total cost of shipping and processing a future possible return of the specified item purchase.

13. A device to calculate a premium for a package return insurance policy, comprising:
a processor; and
a storage device coupled to said processor and storing instructions adapted to be executed by said processor to:
receive from a user a policy requirement for the package return insurance policy;
access data corresponding to a specified item purchase associated with the package return insurance policy; and
determine the premium based on the policy requirement and the accessed data.
